(19) United States
(12) Patent Application Publication
(10) Pub. No.: US 2008/0075077 A1
(43) Pub. Date: Mar. 27, 2008

(54) Search and Intelligent Selection in Multicast Network

(75) Inventors: David Roy, Cornille (FR); Thierry Levesque, Chartres de Bretagne (FR); Franck Geslin, Rennes (FR)

Correspondence Address: COHEN, PONTANI, LIEBERMAN & PAVANE, 551 FIFTH AVENUE, SUITE 1210, NEW YORK, NY, 10176, US

(73) Assignee: France Telecom, Paris (FR)

(21) Appl. No.: 11/662,810

(22) PCT Filed: Sep. 12, 2005
(86) PCT No.: PCT/FR05/50728

§ 371 Date: Oct. 26, 2007

(30) Foreign Application Priority Data
Sep. 13, 2004 (FR) 0409676

(51) Int. Cl. H04L 12/56

(52) U.S. Cl. 370/390

(57) ABSTRACT

A method of distributing data in a multicast network comprising one or more multicast groups. The method uses a remote advertisement server adapted to make available to one or more receivers useful data relating to one or more data source servers, each data source server being adapted to deliver data to one or more multicast groups. Said useful data can be read subsequently in order for one or more of these source servers then to be chosen by means of selection means. Also disclosed are an advertisement server and a system for implementing the method.

The invention relates to the distribution of data in a multicast network including multicast groups supplied with diverse data by data source servers (also called source servers), which data can then be read remotely by user terminals connected to the multicast network.

The multicast mechanism, of the Internet Protocol (IP) or other type, for example, now uses a multicast architecture to broadcast the same information to a virtually unlimited number of users.

In particular, the Internet Protocol multicast technology (also called the IP multicast technology), standardized by the IETF (Internet Engineering Task Force), aims to enable simultaneous broadcasting of packets of data (text, sound, video, etc.) to a plurality of IP addresses. This enables broadcasting applications to be processed with a minimum volume of packets conveyed over the network. The IETF has reassigned a range of IP addresses (called class D addresses) for this purpose, which at the time of writing run from 224.0.1.0 to 239.255.255.255.

The Internet Group Management Protocol (IGMP) enables any user terminal to register at the group IP address of a multicast group, which identifies it so that it can receive contents that can be broadcast to that particular group.

FIG. 1 shows the operating mechanism of version 2 of the Internet Group Management Protocol (IGMPv2). Via a terminal 300, and using the IGMPv2 protocol, the user submits a request 40 for a multicast content identified by an IP (IP class 224.0.0.0/8) address. The IGMPv2 request-information then serves as a control interface between the user 300 and the network 200. Following an IGMP request from the user 300, the network protocols are then responsible for optimum routing to the user 300 of the multicast stream 50 from the set of source servers 100 (here data streams 51, 52, 53 from source servers 101, 102 and 103).

IGMPv2 has a limitation, however: at the time of writing, a plurality of source servers (101, 102, 103, etc.) can send to the IP multicast address. If a user 300 submits an IGMPv2 request for a stream 50, that user runs the risk of recovering all of the traffic sent by the set 100 of source servers.

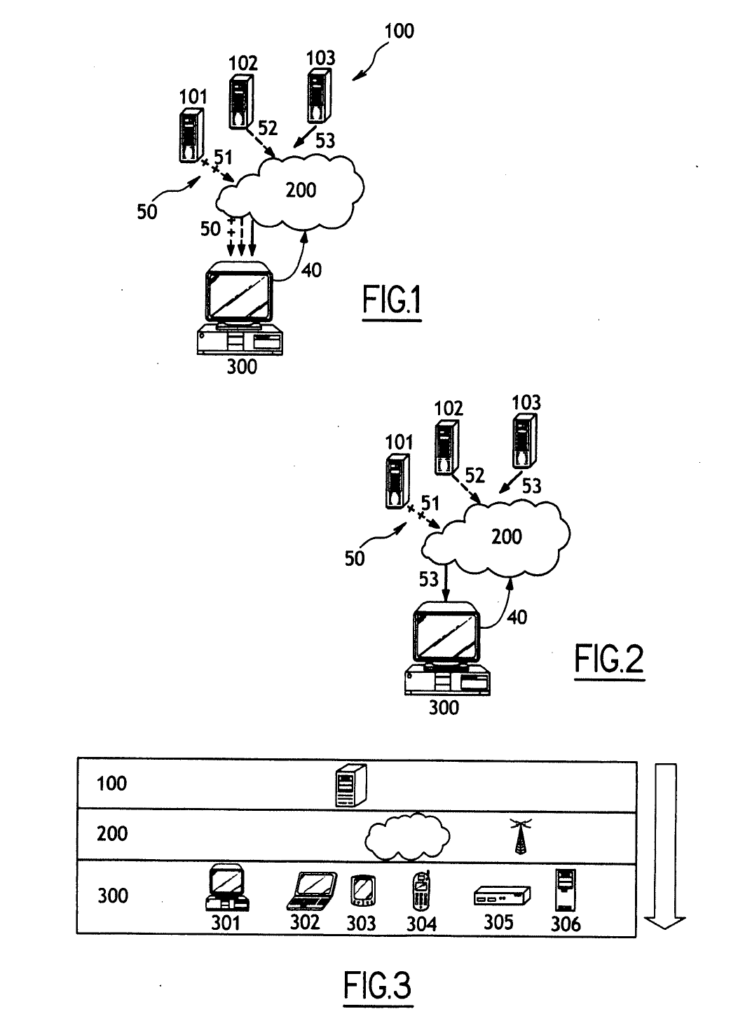

Referring to FIG. 2, a new version 3 of the Internet Group Management Protocol (IGMPv3) attempts to overcome this problem by providing a more sophisticated interface that enables a user 300 to submit a request 40 for the combination of a multicast address and the address of the source server 103, rather than only a multicast address. Thus IGMPv3 authorizes the terminal 300 to receive IP multicast stream data from only the requested source server(s). Thus IGMPv3 enables filtering by source server and offers greater flexibility in the deployment of multicast services. FIG. 2 shows that the user terminal 300 receives only the stream 53 from the requested source server 103 (represented by a solid arrow) and does not receive the data streams 51 and 52 from the source servers 101 and 102, respectively (which are respectively represented by lines of − symbols and lines of + symbols).

However, although IGMPv3 would seem to improve the situation by significantly reducing the amount of information exchanged over the network 200 and by offering the user 300 the possibility of selecting one or more chosen source servers from the set 100 of source servers supplying that user's multicast group(s), it does not provide the user with criteria for making that choice, apart from personal knowledge of the source server.

The multicast technology offering the possibility of easily combining the offers of a plurality of service providers (i.e. source providers) over varied transmission systems, given the multiplication of the services on offer (TV, telephone, data and Internet applications, etc.) at various bit rates (dial-up bit rate, ADSL bit rate, cable bit rate, etc.), and given the diversification of data transmission media (cable, telephone network, radio, optical, etc.) and receiver terminals 300 (computer, mobile telephone, PDA, STB, etc.), and furthermore given the increase in and diversification of data sources, it may be found that this “blind” choice of source server(s) (i.e. a choice made with no knowledge of the technical characteristics of the source server(s)) is not suited to the service to which the user subscribes and/or to the terminal being used, for example.

The rates at which information is exchanged and network congestion have therefore not been sufficiently optimized as yet.

A first objective of the invention is to enable the user 300 to discover multicast source servers, in particular for IGMPv3.

A second objective of the invention is to present the user 300 with the characteristics of the multicast sources to enable the user to make an intelligent choice of multicast content.

A third objective of the invention is thus to pave the way for optimization of intelligent multicast services and of multicast architectures.

To this end, a first aspect of the invention proposes a method of distributing data in a multicast network including one or more multicast groups, characterized in that it uses a remote advertisement server adapted to make available to one or more receivers useful data relating to one or more data source servers and/or to streams delivered thereby, each data source server is adapted to deliver data to one or more multicast groups, said useful data is readable afterwards in order that a choice of one or more of the source servers may then be made via selection means, and said useful data includes one or more of the following fields: identification of each source server; bandwidth of the stream delivered by each source server; identification of the terminals adapted to each source server; availability of each source server; priorities assigned to one source server vis-à-vis another source server.

Other possible features of this method are:
said useful data includes information as to the location of each source server;
the useful data is made available in a structured format, for example by means of XML format tags;
a first additional step of one or more of the receivers receiving and reading useful data and a second additional step of choosing one or more source servers via said selection means on the basis of reading the useful data;
the receiver is a multicast server and the selection means are located in that multicast server or in a user terminal that then receives at least a portion of the useful data broadcast by the multicast server;
the receiver is a user terminal and the selection means are located in that user terminal;
the advertisement server delivers useful information over a unicast network;
the advertisement server delivers the useful information over a multicast network, so the advertisement server is a data source server adapted to deliver the useful data to one or more multicast groups;
the selection means are either operated manually or they are operated automatically by an appropriate program on the basis of particular selection parameters;
the useful data relating to each source server is afterwards stored in memory;
the useful data relating to each source server is afterwards stored in memory in one or more user terminals;
the method further uses application software to consult the useful data stored in memory, to choose either manually or automatically on the basis of particular selection parameters one or more of the source servers for which useful data is stored, to send a request to each data server chosen in this way, and to receive a data stream from each source server to which a request is submitted in this way;
the request is of IGMPv3 type.

A second aspect of the invention proposes a computer program implementing the above method.

A third aspect of the invention proposes an advertisement server connected to a multicast network including one or more multicast groups, characterized in that it is adapted to make remotely available to one or more receivers useful data relating to one or more data source servers and/or to streams delivered thereby, each data source server is adapted to deliver data to one or more multicast groups, said useful data is readable afterwards in order that a choice of one or more of the source servers may then be made via selection means, and said useful data includes one or more of the following fields: identification of each source server; bandwidth of the stream delivered by each source server; identification of the terminals adapted to each source server; availability of each source server; priorities assigned to one source server vis-à-vis another source server.

Other possible features of this advertisement server are:
it is adapted to receive useful data from one or more source servers via the multicast or unicast network and to make it available downstream of itself in a structured format, where appropriate after analyzing and interpreting the data;
the structured format is an XML format;
it is adapted to deliver the useful data over a unicast network;
it is adapted to deliver the useful data over a multicast network, so the advertisement server is itself a data source server adapted to deliver the useful data to one or more multicast groups.

A fourth aspect of the invention proposes a computer program adapted to be executed on an advertisement server having the above features.

A fifth aspect of the invention proposes a user terminal comprising receiver means for receiving via a network at least a portion of the useful data broadcast by an advertisement server having the above features.

A sixth aspect of the invention proposes a computer program adapted to be executed on the above user terminal.

A seventh aspect of the invention proposes a system for distributing data in a multicast network comprising one or more multicast groups, characterized in that it comprises:
a remote data source server;
said advertisement server;
means for reading useful data supplied remotely by the advertisement server;
means for selecting one or more data source servers on the basis of the useful data read.

Other features of this system are:
the reading means are situated in a multicast server and the selection means are located either in that multicast server or in a user terminal which then receives at least a portion of the useful data broadcast by the multicast server;
the reading means are included in a user terminal and the selection means are located in that user terminal;
the selection means are operable either manually or automatically by an appropriate program on the basis of particular selection parameters;
the system further includes a memory for storing the useful data relating to each source server;
that memory is included in one or more user terminals;
the system further comprises means for storing and executing application software for consulting the useful data stored in memory, choosing one or more of the source servers for which useful data is stored either manually or automatically on the basis of particular selection parameters, sending a request to each data server chosen in this way, and receiving a data stream from each source server to which a request is sent in this way;
the request is of IGMPv3 type.

Other features, objects and advantages of the invention become more apparent on reading the following detailed description of the invention, which is given by way of non-limiting example and with reference to the appended drawings, in which:

FIG. 1 represents diagrammatically an operating mechanism of version 2 of the Internet Group Management Protocol (IGMPv2);

FIG. 2 represents diagrammatically an operating mechanism of version 3 of the Internet Group Management Protocol (IGMPv3);

FIG. 3 represents diagrammatically the main components of a data broadcasting system according to the invention;

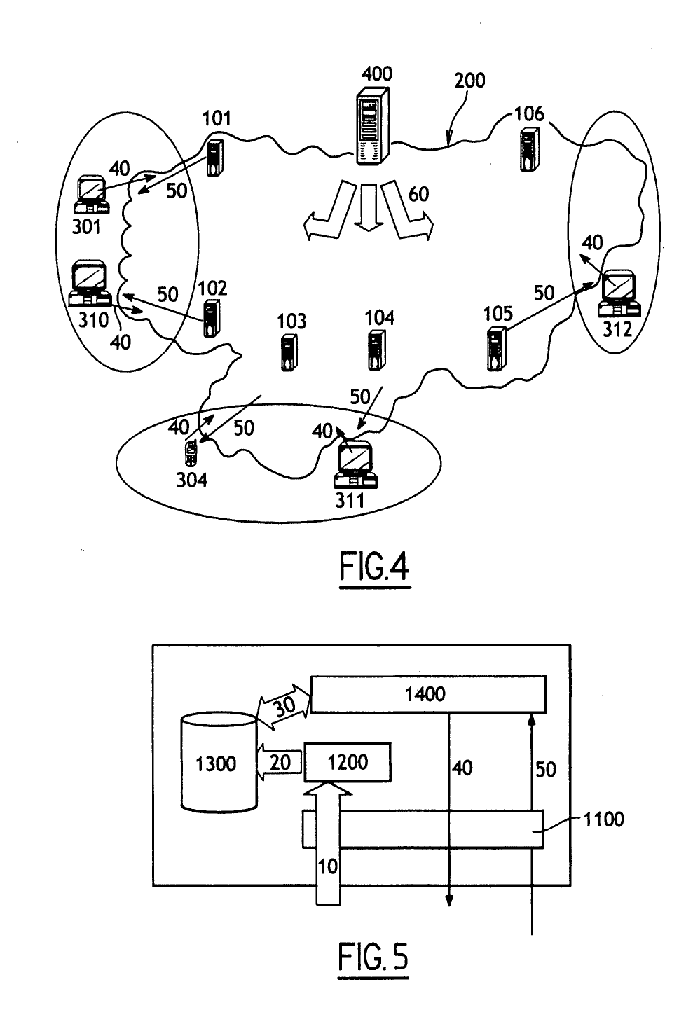

FIG. 4 represents a system for distributing data in a multicast network according to the invention, accompanied by illustrative embodiments;

FIG. 5 represents a method of implementing a method according to the invention at the user level;

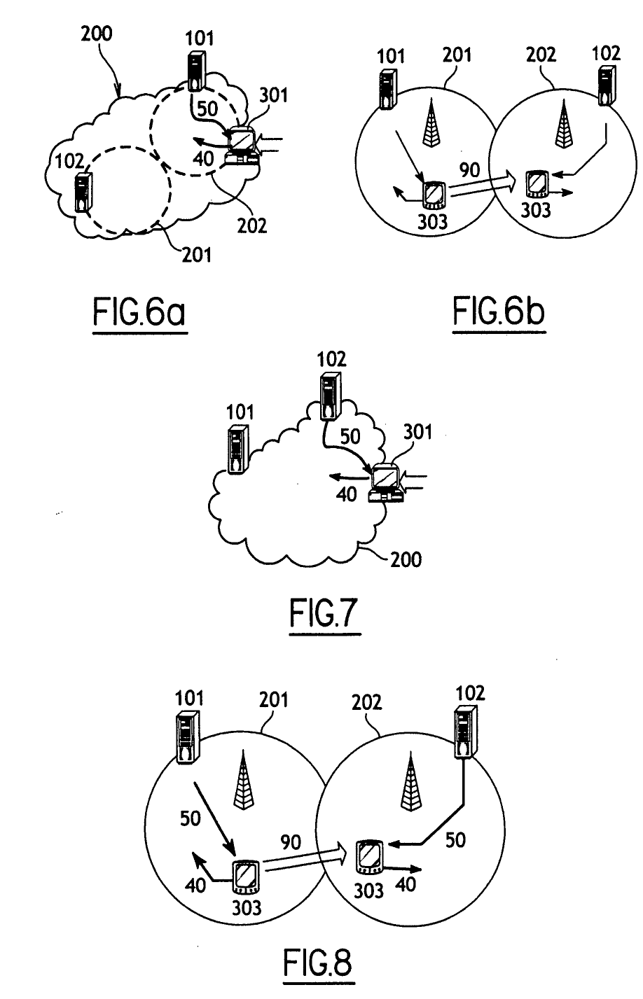

FIGS. 6a and 6b represent a first example of application of the invention to a WAN network and to a radio network, respectively;

FIG. 7 represents a second example of application of the invention; and

FIG. 8 represents a third example of application of the invention.

Referring to FIG. 3, a system adapted to implement the invention comprises three main portions:
a set 100 of data source servers;
a network 200;
a set 300 of user terminals.

The set 100 of source servers can include any type of source server supplying one or more multicast groups. Each of these source servers is identified by its personal IP address and by a multicast group address. These source servers may be simple passive data sources delivering simple information at the request of the user or active data sources that enable some degree of remote interaction with the user via an interface.

The data sent may be of any type (sound, video, files, TV, etc.).

The network 200 has one or more multicast portions, i.e. one or more multicast servers managing one or more multicast groups. These multicast groups are supplied with data by the set 100 of source servers. The network 200 may also provide unicast transmission, in particular to certain users. Internet service providers may encapsulate this data to the IP format, for example. At the time of writing, of all the routers that relay packets over the whole of the Internet, it is IP routers that handle a large proportion of IP multicast and unicast traffic. The data is transmitted via all possible channels: telephone network, cable network, optical fiber, radio (satellite, via base stations, relay stations, etc.), etc.

The set 300 of user terminals receives data streams sent by source servers via the network 200. These user terminals may be of any type, such as a fixed computer 301, a laptop computer 302, a personal digital assistant (PDA) 303, a mobile telephone 304, a set top box (STB) 305, and an IGMP gateway 306. This set 300 of terminals must necessarily be adapted to connect to the network 200, for example via an IP interface, and therefore includes means for connecting to and where applicable means for navigating in that network. Thus a terminal may have a multicast IP interface, for example with IGMPv3 multicast capabilities.

Accordingly, the invention applies very well to multicast IP architectures (fixed, wireless, mobile networks) that support the IGMPv3 interface.

Referring to FIG. 4, a particular entity 400 called an advertisement server is added to the architecture of the system according to the invention. This advertisement server 400 is located in the network 200. Its role is to advertise multicast source servers (here the servers 101, 102, 103, 104, 105, 106),and to provide useful data relating to them (such as their technical characteristics).

For this purpose, the advertisement server 400 is connected via the multicast or unicast private network 200 to particular source servers 101, 102, 103, 104, 105, 106 supplying one or more multicast groups. This connection enables the advertisement server to receive from these source servers data advising it of the particular characteristics of the source servers: for example, the advertisement server 400 can in this way find out the bit rate, address, bandwidth and location of each of the source servers. These characteristics can be calculated in the advertisement server and/or supplied by each of the source servers concerned. In particular, these characteristics can be updated regularly.

The advertisement server 400 is therefore adapted to organize and structure these source server characteristics so as thereafter to make useful data relating to the source servers and/or to the streams they deliver available to one or more receivers (such as a user terminal, an operator or another server), this useful data delivered by the advertisement server being selected to assist with subsequently making a judicious choice of one or more of those source servers (at the level of a user terminal, an operator or a server).

This useful data may include one or more of the following:

(1) identification of each source server;

(2) information on the location of each source server (spatial location, etc.);

(3) bandwidth of the stream delivered by each source server;

(4) availability of each source server (time of day it begins to send data, time of day it ceases to send data).

This useful data can be obtained relatively directly.

The advertisement server may additionally or instead supply by way of useful data one or more of the following:

(5) identification of terminals suited to each source server;

(6) priorities assigned to one source server vis-à-vis another source server.

This useful data can in particular take into account the technical characteristics of the source servers (including the useful data items (1) to (4) listed above).

For example, terminals (mobile telephones, computers, PDA, STB, etc.) appropriate to each source server may be identified by analyzing the bit rate of each server.

For example, priority may be assigned to one source server rather than another, both source servers supplying the same sort of data, on the grounds that they do not have the same technical characteristics (bandwidth, bit rate, etc.).

One server can also be given priority over another source server according to the terminal used. For example, priority could be assigned to a first source server vis-à-vis a second source server if the terminal used is a mobile telephone and, alternatively, priority could be assigned to the second source server vis-à-vis the first source server if the terminal used is a computer with an ADSL connection (the bit rate or location useful data could be used to determine these priorities, for example).

This useful data is structured so that it can be received and read subsequently by different types of receivers. For example, XML tags (contained in a useful data file) may provide a structure for transporting useful data (see Appendices 1 and 2, for example).

The advertisement server 400 therefore implements a useful data model defined by the invention.

Note that a computer program including instructions necessary for implementing the method according to the invention may be used in the advertisement server 400. Moreover, a user terminal may include receiver means and a computer program for receiving via the network 200 at least some of the useful data broadcast by the advertisement server.

In the model represented by the XML algorithm in Appendix 1 and represented diagrammatically in Appendix 2, the IGMPv3SourceManagement set of multicast groups contains each multicast group (SingleGMPv3Service) with its multicast IP address (MulticastAddress), and then each source server (SSMSource) with its unicast IP address (SourceAddress) in each multicast group.

Thus, for each source server, the XML file may contain (in SourceClassifier) generic criteria characterizing a source server (here an IGMPv3 source server), for example by means of the following tags:

PriorityInformation (integer type): this element corresponds to the useful data item (6) referred to above.

Example of use: a redundant multicast mechanism using this tag may be envisaged whereby two multicast source servers are provided for the same stream, consisting of a primary server and a back-up server. Referring to FIG. 4, the user 312 therefore chooses the source server 105 as the primary source server and the source server 106 as the secondary source server, even if the source servers 105 and 106 supply the same multicast group to which the user 312 is connected.

NetworkLocationInformation (string type ): this element is a character string that provides information as to the location of the source server (corresponding to the useful data item (2) referred to above). The location may be a set (pool) of IP addresses, for example, a GSM cell, a GPS coordinate, a WiFi access point, etc.

Example of use: this tag enables a network operator to distribute over the network a plurality of sources of the same stream. Referring to FIG. 4, using this tag, the user 301 chooses the source server 101 and the user 310 chooses the source server 102, for location reasons and even if the source servers 101 and 102 supply the same multicast group to which the users 301 and 310 are connected. Thus the propagation of the multicast stream is limited and the multicast stream transit times are improved.

BandwidthInformation (long type): this element supplies the bit rate in kbps at the output of the source server (corresponding to the useful data item (3) referred to above).

Example of use: definition for the same stream of a plurality of source servers each delivering the same content but at different bit rates (e.g. 512 kbps, 1 Mbps, 2 Mbps, etc.). The user can then connect to the source that delivers the stream according to the user's service agreement, in other words according to available reception bandwidth. Referring to FIG. 4, the user 304 (here using a mobile telephone terminal) chooses the source server 103 that delivers 64 kbyte/s while the user 311 (here using an ADSL computer terminal) chooses the source server 104 that delivers 1 Mbps), even if the source servers 103 and 104 supply the same multicast group to which the users 304 and 311 are connected.

TargetTerminalInformation (string type): this element supplies technical characteristics of the terminal that the source targets (corresponding to the useful data item (5) referred to above).

Example of use: identification of the terminal type (PDA, PC), the network access capacities of the terminal, etc.

SourceAvailabilityInformation (complex type): this element supplies the times of day at which the availability of the multicast source begins and ends (corresponding to the useful data item (4) referred to above).

Example of use: preventing a multicast source server sending continuously. For example, shutting down three out of four multicast servers during slack periods.

Other types of tag (i.e. useful data) can easily be imagined, subsequently representing source server selection criteria.

These selection criteria may also be combined with each other to yield new selection criteria.

On request, the advertisement server 400 then delivers (60) this useful data in multicast mode (the advertisement server 400 then being a data source server itself) or in unicast mode via the same network as the multicast streams or a separate network.

The IGMP multicast source advertisement and selection protocol may also take the following form, for example:
a layer of useful data to the XML format;
a multicast over UDP/IP transport layer to obtain the benefit of an optimum distribution of the useful data or a unicast over TCP/IP layer for on-demand distribution. If the advertisement is effected in multicast mode, the multicast IP address must be known to the terminals.

This useful data (or the structured file, for example in XML) are then received and read remotely of the advertisement server 400, for example by means of one of the receivers that requested this useful data, the receiver being a user terminal 301, 310, 304, 311, 305 or 312, for example, and/or a server for relaying this data to terminals in multicast or unicast mode.

Once this useful data has been received and read by the receiver, a choice of one or more source servers is arrived at, via selection means, on the basis of the useful data that has been read.

This choice may be made in the receiver itself. The selection means are then located in the receiver.

If the receiver is a server or an operator, at least a portion of the useful data may then be transmitted in multicast or unicast mode to the user terminal (301, 310, 304, 311, 305 or 312), which then makes the choice. The selection means are then located in the terminal.

Selection may be manual (by keyboard, mouse, touch-sensitive screen, etc.) or automatic, for example by an appropriate program using particular selection parameters.

The useful data relating to each source server (whether chosen or not) may then be stored in memory, for example in the user terminal or in a server.

Knowing the useful data relating to the source servers, the user 301, 310, 304, 311 or 312 can then send a request 40 to the source server(s) that it has selected in order for the server(s) to send it the data 50 that it holds. This request may be of the IGMPv3 type, for example (as defined above).

One embodiment of the invention at the level of the user, or rather the user's terminal, is described with reference to FIG. 5.

The user connects either to the channel of the advertisement server (for example of IGMPv3 type) for the multicast source servers via the user interface 1200 of the terminal or to an Internet server which has recovered the useful data from the advertisement server, and then (10) recovers the useful data (i.e. the list of source servers and the useful data for each multicast group).

The user then (20) stores the useful data in the memory 1300 of the terminal. The transport protocol may include a specific mechanism for detecting updating of the useful data taking into account the multicast sources that have just been selected. The useful data may then be used by an application layer 1400 (i.e. by application software) in the terminal, in order to arrive at a choice of a multicast source intelligently, on the basis of this useful data.

The application software 1400 is therefore used to consult the useful data stored in memory and to choose one or more of the source servers for which useful data is stored either manually or automatically (via selection means). Although this choice is automatic, it may nevertheless depend on general selection parameters that are either predetermined or determined afterwards by the user. Once the selection has been made, this application software 1400 sends a request 40 to each data server selected in this way and receives a data stream 50 from each source server to which a request is sent in this way.

This application layer 1400 can also update (30) the useful data in the database (in the memory 1300), taking account of the selection that has just been made.

Thus the method of the invention advertises the source servers to the user and provides means for classifying the source servers as a function of certain criteria, thus enabling a user to choose the most appropriate multicast source (via the user's multicast group or unicast connection).

Unlike previous techniques, the invention can therefore define how the user terminal can intelligently discover and choose one or more source servers, and for example subscribe to them (through storage in the memory 1300).

### EXAMPLE 1

This first example describes an application of the NetworkLocationInformation tag with reference to FIG. 6. The tag supplies information on the location of the source servers 101 and 102 of a multicast stream. This tag can be used by a fixed terminal 301, as shown in FIG. 6a, for example in a WAN network 200, following the request 40, to receive the stream 50 from the multicast source server 101 that is closest to it, or by a mobile terminal 303, as shown in FIG. 6b, to connect to the source server broadcasting in its cell (here the mobile terminal 303 effects a movement 90 from the cell 201 to the cell 202 and, by means of the location tag, can change source server (from 101 to 102)).

Advantages that can be obtained by using this tag:
optimum broadcasting of multicast contents over WAN networks;
improvement of QoS, limitation of transit times;
management of mobility, continuity of service.

### EXAMPLE 2

Referring to FIG. 7, the BandwidthInformation tag is used in this example to enable a heterogeneous (in terms of bit rate) terminal 301 to connect to the source server 102 that delivers the service according to the service agreement. Accordingly, a terminal 301 with a 512 kbps ADSL connection is connected to the source delivering the service at a bit rate of 512 kbps while a second terminal with a higher bandwidth, for example 2 Mbps, is connected to the source server 101 delivering the same service but at a significantly higher quality than the 512 Kbps source.

Advantage that can be obtained by using this tag: homogenization of services.

### EXAMPLE 3

Referring to FIG. 8, it is proposed here to describe the TargetTerminalInformation tag. This tag may be used, for example, in a context in which a terminal 303 has a plurality of network interfaces, for example a mobile terminal with a GPRS interface and a UMTS interface. Using the TargetTerminalInformation tag means that the terminals that are targeted by a source server 101 or 102 may be characterized. Thus it may be considered that a source server 101 is responsible for broadcasting a service for GPRS terminals over the network 201 and another source server 102 is responsible for broadcasting the same service for UMTS terminals over the network 202. The terminal is therefore adapted to switch from a GPRS interface to a UMTS interface without losing the received data upon the movement 90 of the terminal 303.

Advantage that can be obtained by using this tag: personalized service for each installed terminal base.

APPENDIX 1
<?xml version=“1.0” encoding=“UTF-8”?>
<xs:schema xmlns:xs=“http://www.w3.org/2001/XMLSchema” elementFormDefault=“qualified”
attributeFormDefault=“unqualified”>

<xs:element name=“IGMPv3SourceManagement”>

<xs :complexType>

<xs:sequence>

<xs:element name=“SingleIGMPv3Service” type=“IGMPv3ServiceType” maxOccurs=“unbounded”/>

</xs:sequence>

</xs :complexType>

</xs:element>
<xs:complexType name=“IGMPv3ServiceType”>

<xs:sequence>

<xs:element name=“MulticastAddress” type=“xs:string”/>
<xs:element name=“Port” type=“xs:integer” minOccurs=“0”/>
<xs:element name=“SSMSource” type=“OneSource” maxOccurs=“unbounded”/>

</xs:sequence>
<xs:attribute name=“ServiceName” type=“xs:string”/>
<xs:attribute name=“SegID” type=“Integer16”/>

</xs :complexType>
<xs:complexType name=“OneSource”>

<xs:sequence>

<xs:element name=“SourceAddress” type=“xs:string”/>
<xs:element name=“SourceClassifier” type=“SourceClassifierType” minOccurs=“0”/>

</xs:sequence>
<xs:attribute name=“SourceName” type=“xs:string”/>

</xs :complexType>
<xs:complexType name=“SourceClassifierType”>

<xs:sequence>

<xs:element name=“PriorityInformation” type=“xs:integer” minOccurs=“0”/>
<xs:element name=“NetworkLocationInformation” type=“xs:string” minOccurs=“0”/>
<xs:element name=“BandwidthInformation” type=“xs:long” minOccurs=“0”/>
<xs:element name=“TargetTerminalInformation” type=“xs:string” minOccurs=“0”/>
<xs:element name=“SourceAvailabilityInformation” type=“AvailabilityType” minOccurs=“0”/>
<xs:element name=“PrivateInformation” type=“PrivateType” minOccurs=“0” maxOccurs=“unbounded”/>

</xs:sequence>

</xs:complexType>
<xs:complexType name=“PrivateType”>

<xs:sequence>

<xs:element name=“Type” type=“String64”/>
<xs:element name=“Value” type=“xs:string”/>

</xs:sequence>

</xs :complexType>
<xs:complexType name=“AvailabilityType”>

<xs:sequence>

<xs:element name=“StartTime” type=“xs:dateTime”/>
<xs:element name=“StopTime” type=“xs:dateTime”/>

</xs:sequence>

</xs:complexType>
<xs:simpleType name=“String64”>

<xs:restriction base=“xs:string”>

<xs:maxLength value=“64”/>

</xs:restriction>

</xs:simpleType>
<xs:simpleType name=“Integer16”>

<xsrestriction base=“xs:integer”>

<xs:maxLength value=“16”/>

</xs:restriction>

</xs:simpleType>

</xs:schema>

[image]

1. A method of distributing data in a multicast network including one or more multicast groups, characterized in that it uses a remote advertisement server adapted to make available to one or more receivers useful data relating to one or more data source servers and/or to streams delivered thereby, each data source server is adapted to deliver data to one or more multicast groups, said useful data is readable afterwards in order that a choice of one or more of the source servers may then be made via selection means, and said useful data includes one or more of the following fields: identification of each source server; bandwidth of the stream delivered by each source server; identification of the terminals adapted to each source server; availability of each source server; priorities assigned to one source server vis-à-vis another source server.

2. The method according to claim 1, wherein said useful data includes information as to the location of each source server.

3. The method according to claim 1, wherein the useful data is made available in a structured format.

4. The method according to claim 1, wherein the useful data is made available in a structured format by means of XML format tags.

5. The method according to claim 1, wherein it includes a first additional step of one or more of the receivers receiving and reading useful data and a second additional step of choosing one or more source servers via said selection means on the basis of reading the useful data.

6. The method according to claim 5, wherein the receiver is a multicast server and the selection means are located in that multicast server or in a user terminal that then receives at least a portion of the useful data broadcast by the multicast server.

7. The method according to claim 5, wherein the receiver is a user terminal and the selection means are located in that user terminal.

8. The method according to claim 7, wherein the advertisement server delivers useful information over a unicast network.

9. The method according to claim 6, wherein the advertisement server delivers the useful information over a multicast network, so the advertisement server is a data source server adapted to deliver the useful data to one or more multicast groups.

10. The method according to claim 5, wherein the selection means are either operated manually or are operated automatically by an appropriate program on the basis of particular selection parameters.

11. The method according to claim 1, wherein the useful data relating to each source server is afterwards stored in memory.

12. The method according to claim 1, wherein the useful data relating to each source server is afterwards stored in memory in one or more user terminals.

13. The method according to claim 11, wherein it further uses application software to consult the useful data stored in memory, to choose one or more of the source servers for which useful data is stored either manually or automatically on the basis of particular selection parameters, to send a request to each data server chosen in this way, and to receive a data stream from each source server to which a request is submitted in this way.

14. The method according claim 13, wherein the request is of IGMPv3 type.

15. A computer program implementing the method according to claim 13.

16. An advertisement server connected to a multicast network including one or more multicast groups, characterized in that it is adapted to make remotely available to one or more receivers useful data relating to one or more data source servers and/or to streams delivered thereby, each data source server is adapted to deliver data to one or more multicast groups, said useful data is readable afterwards in order that a choice of one or more of the source servers may then be made via selection means, and said useful data includes one or more of the following fields: identification of each source server; bandwidth of the stream delivered by each source server; identification of the terminals adapted to each source server; availability of each source server; priorities assigned to one source server vis-à-vis another source server.

17. The advertisement server according to claim 16, wherein it is adapted to receive useful data from one or more source servers via the multicast network and to make it available downstream of itself in a structured format, where appropriate after analyzing and interpreting the data.

18. The advertisement server according to claim 17, wherein the structured format is an XML format.

19. The advertisement server according to claim 16, wherein it is adapted to deliver the useful data over a unicast network.

20. The advertisement server according to claim 16 wherein it is adapted to deliver the useful data over a multicast network, so the advertisement server is itself a data source server adapted to deliver the useful data to one or more multicast groups.

21. A computer program adapted to be executed on an advertisement server according to claim 16.

22. A user terminal characterized in that it comprises receiver means for receiving via a network at least a portion of the useful data broadcast by an advertisement server according to claim 16.

23. A computer program adapted to be executed on a user terminal according to claim 22.

24. A system for distributing data in a multicast network comprising one or more multicast groups comprising:
a remote data source server;
an advertisement server according to claim 16;
means for reading useful data supplied remotely by the advertisement server;
means for selecting one or more data servers on the basis of the useful data read.

25. The system according to claim 24, wherein the reading means are situated in a multicast server and the selection means are located either in that multicast server or in a user terminal which then receives at least a portion of the useful data broadcast by the multicast server.

26. The system according to claim 25, wherein the reading means are included in a user terminal and the selection means are located in that user terminal.

27. The system according to claim 24, wherein the selection means are operable either manually or automatically by an appropriate program on the basis of particular selection parameters.

28. The system according to claim 24, wherein it further includes a memory for storing the useful data relating to each source server.

29. The system according to claim 28, wherein the memory is included in one or more user terminals.

30. The system according to claim 28, wherein it further comprises means for storing and executing application software for consulting the useful data stored in memory, choosing one or more of the source servers for which useful data is stored either manually or automatically on the basis of particular selection parameters, sending a request to each data server chosen in this way, and receiving a data stream from each source server to which a request is sent in this way.

31. The system according to claim 30 wherein the request is of IGMPv3 type.
